(19) United States
(12) Patent Application Publication
(10) Pub. No.: US 2022/0340063 A1
(43) Pub. Date: Oct. 27, 2022

(54) VEHICLE SEAT BACKREST INCLUDING AT LEAST ONE VIBRATING DEVICE

(71) Applicant: FAURECIA Sièges d'Automobile, Nanterre (FR)

(72) Inventors: Stéphane SOLTNER, Mailleroncourt Charrette (FR); Jérôme PLANSON, Angerville (FR); Imen CHERIAA, Etampes (FR)

(21) Appl. No.: 17/724,962

(22) Filed: Apr. 20, 2022

(30) Foreign Application Priority Data
Apr. 22, 2021 (FR) 2104224

(51) Int. Cl. B60N 2/90; A61H 23/02

(52) U.S. Cl. CPC B60N 2/976; A61H 23/02

(57) ABSTRACT

A backrest of a vehicle seat comprises a backrest frame, a support plate fixed to the backrest frame, and at least one vibrating device. Each vibrating device is fixed to the support plate by means of at least one damping element. Preferably, each vibrating device is fixed on a face of the support plate opposite to the face intended to be oriented towards an occupant of the seat, at least a portion of each vibrating device being received in a respective through-hole in the support plate.

### PRIORITY CLAIM

This application claims priority to French Patent Application No. FR2104224, filed Apr. 22, 2021, which is expressly incorporated by reference herein.

### BACKGROUND

The present disclosure relates to a backrest of a vehicle seat, in particular of a motor vehicle, incorporating at least one vibrating device. Also described is a vehicle seat comprising such a backrest.

### SUMMARY

According to the present disclosure, a vehicle seat backrest comprises a backrest frame, a support plate fixed to the backrest frame, and at least one vibrating device, each vibrating device being fixed to the support plate by means of at least one damping element.

In illustrative embodiments, each vibrating device is at least partially isolated from the seat base frame by the damping element or elements. In addition, this solution is particularly compact and makes it possible to produce a thin seat backrest.

In illustrative embodiments, the vehicle seat backrest comprises one or more of the following features, alone or in combination:
the support plate comprises a first face intended to be oriented towards an occupant of the vehicle seat and a second face opposite to the first face, each vibrating device being fixed on the second face of the support plate, at least a portion of each vibrating device being received in a respective through-hole in the support plate;
each vibrating device is fixed to the support plate at at least two points, preferably at least three points, more preferably at exactly three points, the at least two points preferably being evenly distributed angularly around the vibrating device;
at least one damping element in the form of a pin made at least partly of elastic material, preferably entirely of elastic material, is fixed on the support plate on the one hand, and on the vibrating device on the other hand, at each point where the vibrating device is fixed on the support plate;
each pin forming a damping element comprises a first groove for fixing the pin to the support plate, and a second groove at a distance from the first groove, for fixing to the vibrating element, the second groove preferably receiving a tab of the vibrating device;
the support plate is fixed to the backrest frame by elastically deformable fixing means;
the backrest frame comprises a first upright, a second upright, a first crosspiece, and a second crosspiece, the elastically deformable fixing means comprise at least one spring wire fixed to the first crosspiece and to the second crosspiece, and the support plate is preferably fixed to the at least one spring wire, in particular by snap-fitting;
the vehicle seat backrest comprises an electronic control unit for controlling the at least one vibrating device, the electronic control unit being fixed to the at least one spring wire, in particular by snap-fitting;
at least one element contributing to the implementation of a comfort function, is directly or indirectly fixed to the support plate;
a fan is fixed to the support plate, preferably on the second face of the support plate, the fan and the seat backrest being shaped so that the air blown by the fan is blown out of the backrest via the face of the backrest intended to be oriented towards an occupant of the vehicle seat;
at least one, preferably at least two, more preferably at least three lumbar support pads are directly or indirectly fixed to the support plate, preferably on the first face of the support plate intended to be oriented towards an occupant of the vehicle seat, each vibrating device preferably also being in contact with a lumbar support pad;
a plurality of inflatable pouches are fixed to the support plate, preferably on the first face of the support plate intended to be oriented towards an occupant of the vehicle seat, via padding of the backrest where appropriate, the inflatable pouches being supplied with air by an air pump via a valve, the valve also being fixed to the support plate, preferably on the second face of the support plate;
each vibrating device is partially received in a respective hole in the support plate, with a clearance, the clearance preferably being between 2 mm and 3 mm;
the seat backrest further comprises padding fixed to the backrest frame and/or the support plate, the padding preferably having a thickness of between 20 mm and 35 mm, more preferably between 25 mm and 30 mm.

In illustrative embodiments, a vehicle seat comprises a seat base, with a seat base frame, and a backrest as described above in all its combinations, the backrest frame being fixed to the seat base frame, preferably in a manner enabling it to pivot about a transverse axis.

In illustrative embodiments, a method for mounting a seat backrest as described above in all its combinations, comprises the steps of:

i) providing a backrest frame, a support plate, at least one vibrating device, and at least one damping element in the form of a pin made at least partly of elastic material, having a first groove and a second groove;

ii) inserting the at least one damping element into a hole in the support plate via the first face of the support plate, the face being intended to be oriented towards an occupant of the vehicle seat, until the first groove receives the support plate;

iii) fixing the vibrating device on the at least one damping element, preferably until the second groove receives a tab of the vibrating device; and/or

iv) fixing the support plate to the backrest frame.

In illustrative embodiments, the support plate may be fixed on the backrest frame before or after the vibrating device is fixed on the support plate.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 schematically represents a side view of an example of a vehicle seat;

FIG. 2 schematically represents a perspective view of the backrest frame of the vehicle seat of FIG. 1, to which is fixed a support plate equipped with vibrating devices;

FIG. 3 schematically represents, from an opposite perspective, the same backrest frame to which is fixed the support plate equipped with vibrating devices as in FIG. 2;

FIG. 4 schematically represents a section view along line IV-IV showing details of the support plate illustrated in FIGS. 2 and 3;

FIG. 5 is a view similar to FIG. 2, in which inflatable lumbar support pads are fixed to the support plate;

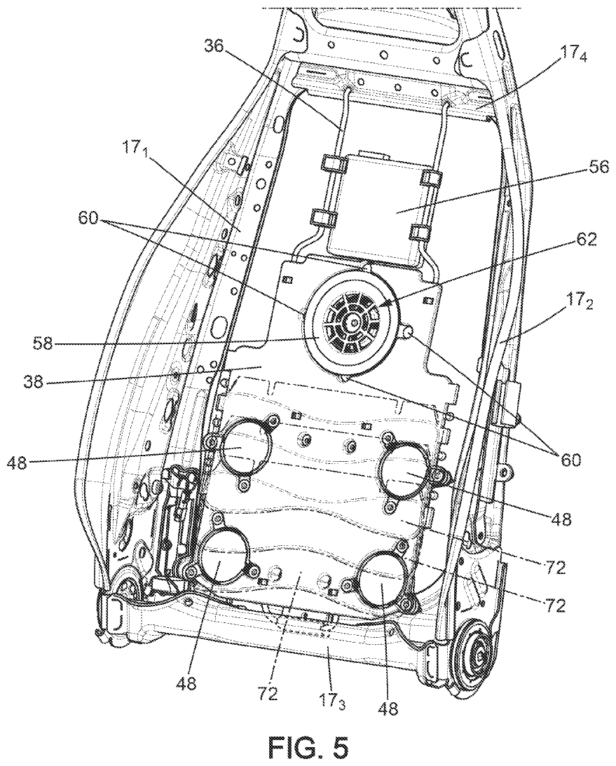

FIG. 6 schematically represents a view similar to FIG. 2, in which inflatable pouches are fixed to the padding of the backrest, the padding being fixed to the support plate; and

FIG. 7 schematically represents a perspective view of the seat backrest of FIG. 6, equipped with a cover over its padding.

### DETAILED DESCRIPTION

In the various figures, the same references designate identical or similar elements. For conciseness, only those elements which are useful to understanding the described embodiment are shown in the figures and described in detail below.

In the following description, when referring to absolute position qualifiers, such as the terms “front”, “rear”, “top”, “bottom”, “left”, “right”, etc., or relative qualifiers, such as the terms “above”, “below”, “upper”, “lower”, etc., or to orientation qualifiers, such as “horizontal”, “vertical”, etc., unless otherwise specified these are in reference to the orientation in the figures or of a vehicle seat in its normal position of use.

In particular, the longitudinal direction X means the longitudinal direction of the seat. The longitudinal direction of the seat is considered to be the same as the longitudinal direction of the motor vehicle in which the seat is mounted. This longitudinal direction X corresponds to the normal direction of travel of the vehicle. The longitudinal direction X is horizontal. The transverse direction Y of the seat thus corresponds to the transverse or lateral direction of the motor vehicle. This transverse direction corresponds to a direction perpendicular to the normal direction of travel of the vehicle. The transverse direction Y is horizontal. Finally, the vertical direction Z is a vertical direction of the seat, perpendicular to the longitudinal and transverse directions.

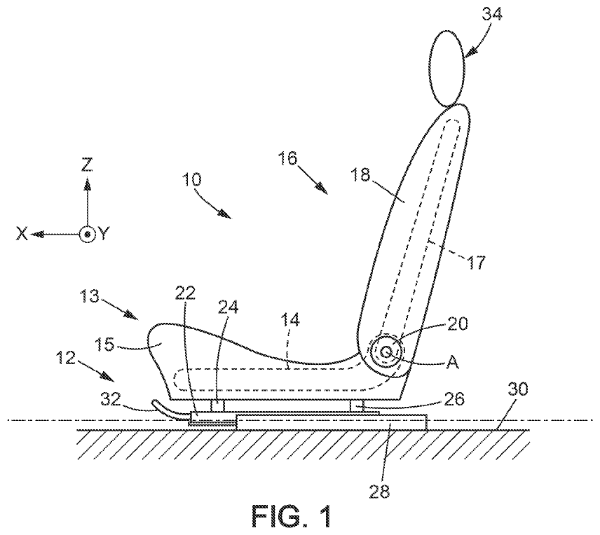

FIG. 1 schematically represents a motor vehicle seat 10 mounted on a mechanism with track assemblies 12.

The seat 10 comprises a seat base 13, with a seat base frame 14 and seat base upholstery 15, on which is mounted a backrest 16, with a backrest frame 17 and backrest upholstery 18. The backrest frame 17 here pivots about a transverse axis A, relative to the seat base frame 14. To allow this, a hinge mechanism 20 is arranged between the seat base frame 14 and the backrest frame 17.

The seat base 13 is mounted on movable sections 22, also called slides or male sections, by means of feet 24, 26. Each movable section 22 is part of a track assembly 12 and is associated with a fixed section 28. The fixed section 28 is also called a rail or female section. The fixed section 28 is fixed to the floor 30 of a motor vehicle.

In this example, the seat 10 comprises a manual control element 32, called a release lever, for controlling the sliding of the track assemblies 12. This manual control element 32 makes it possible in particular to lock and unlock the systems which stop the sliding of the movable sections 22 relative to the respective fixed sections 28. Once the stop systems have been unlocked, the manual control element 32 may also be used to cause the movable sections 22 to slide relative to their respective fixed sections 28 of the track assembly 12 in the longitudinal direction X of the track assemblies 12. The fixed 28 and movable 22 sections of the track assemblies 12 are generally made of metal.

Alternatively, the movement of the movable sections 22 relative to the fixed sections 28 is controlled by means of an actuator.

According to the example shown, the seat 10 may also comprise a headrest 34. The headrest 34 may also comprise a headrest frame and headrest upholstery.

In the following, the backrest 16 of the vehicle seat 10 is described in more detail.

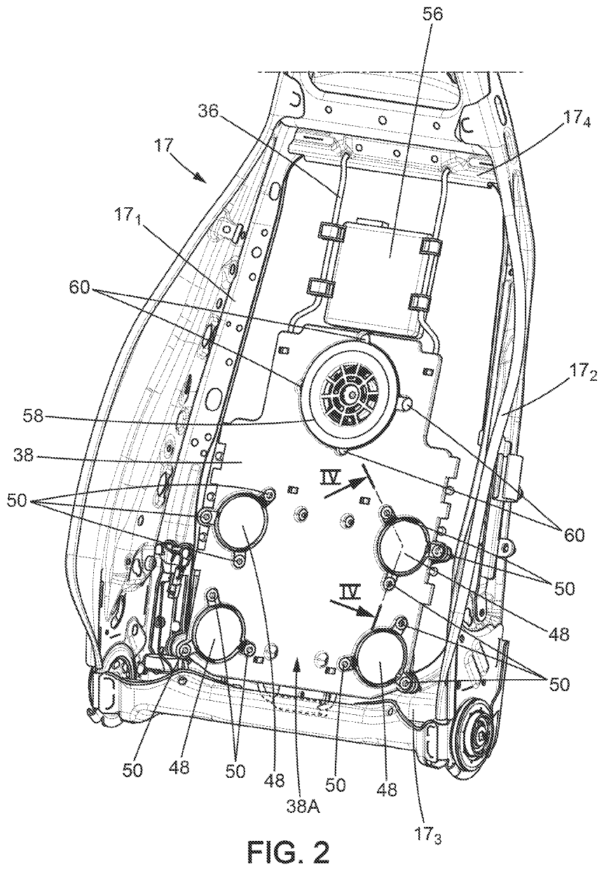

FIG. 2 schematically illustrates the backrest frame 17. This backrest frame comprises two uprights 17₁, 17₂, integral with two crosspieces 17₃, 17₄, one referred to as the lower crosspiece 17₃ and one as the upper crosspiece 17₄. The backrest frame 17 thus has the shape of a picture frame and defines a hollow space in its center.

The backrest frame 17 may be a single unit, meaning created as a single piece. Alternatively, however, the backrest frame 17 is created by fixing several component parts together, which in particular may correspond to the uprights 17₁, 17₂ and the crosspieces 17₃, 17₄. These component parts may in particular be welded together.

A wire 36 forming a spring (or spring wire), here bent, is stretched between the upper crosspiece 17₄ and the lower crosspiece 17₃. The wire 36 is fixed at each of its ends to the upper crosspiece 17₄, and substantially in its middle to the lower crosspiece 17₃. Alternatively, two separate wires may be stretched between the upper crosspiece 17₄ and the lower crosspiece 17₃. The wire 36 is for example made of metal to ensure a certain rigidity while retaining a capacity for elastic deformation. The wire 36 preferably winds back and forth within a plane.

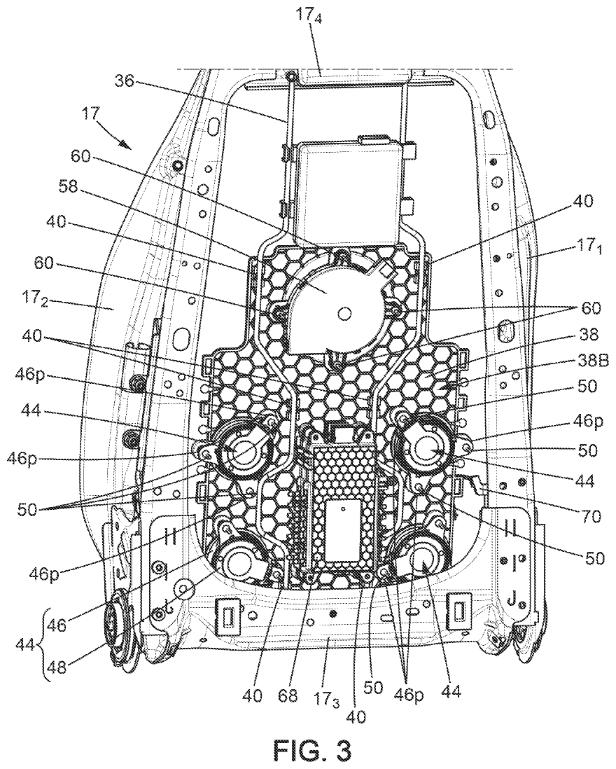

Here, a support plate 38 is fixed to this bent wire 36. The support plate 38 comprises two faces:
a first face 38A intended to be oriented towards the occupant of the vehicle seat 10, visible in FIG. 2; and
a second face 38B, opposite to the first face 38A, visible in FIG. 3.

The support plate 38 is for example snap-fitted on the wire 36. For this purpose, the support plate 38 here comprises, on its second face 38B, snap-fit reliefs 40, suitable for engaging with the wire 36.

The support plate 38 may in particular be made of plastic. To ensure satisfactory rigidity, the support plate 38 may have honeycomb reliefs, in particular on the second face 38B of the support plate 38.

Here, four vibrating devices 42 are fixed on the support plate 38. In the example shown, each vibrating device 42 comprises a frame 46, a vibrating element 48, and means, not shown, for vibrating the vibrating element 48. The means for vibrating the vibrating element 48 are accessible to those skilled in the art. These means may in particular comprise a coil for vibrating a vibrating body in the vibrating element, made of a magnetic material or integral with a piston made of a magnetic material.

The vibrations of each vibrating device 42 are advantageously directed in the direction of an axis A1 of the vibrating device 42 concerned, substantially normal to the plane of the support plate 38.

Each vibrating device 42 is devoid of any vibrating membrane. Each vibrating device 42 is thus distinguished from a loudspeaker in that each vibrating device 42 aims above all to transmit vibrations (or structure-borne noise) to the occupant of the vehicle seat, rather than sound (airborne noise). The vibrations of each vibrating device 42 may in particular be within a range of frequencies which is inaudible. The frequencies of the vibrations of the vibrating devices 42 may in particular be outside the 20 Hz to 20 kHz range. Additionally or alternatively, the vibrating element 48 may have a shape such that its three dimensions are substantially of the same order of magnitude. In particular, one dimension of the vibrating element 48, measured in the direction of the axis A1 of the vibrating device 42, is not a hundred times less, preferably ten times less, than the other dimensions of the vibrating element 42, measured in a plane perpendicular to the axis A1 of the vibrating device 42.

Here the vibrating element 48 is of substantially cylindrical shape, of circular section, and its axis is the axis A1 of the vibrating device 42. The vibrating element 48 is fixed to the frame 46, in particular by snap-fitting.

The vibrating element 48 is received in a complementary cylindrical portion 46c of the frame 46. The cylindrical portion 46c may be closed off, in whole or in part, on its face opposite to its face intended to be oriented towards an occupant of the seat of vehicle. The cylindrical portion 46c of the frame 46 has as its axis the axis A1 of the vibrating device 42.

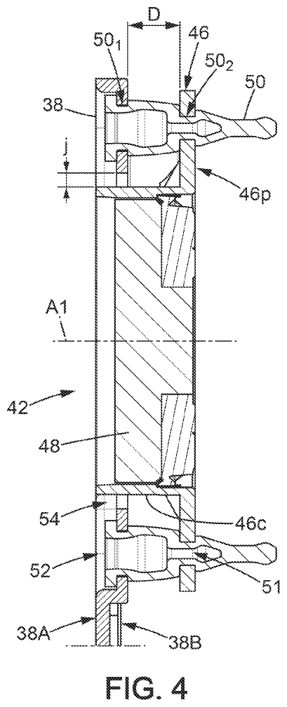

The frame 46 of each vibrating device 42 comprises, in addition to this cylindrical portion 46c, three tabs 46p. Each of the three tabs 46p has the shape of a substantially rectangular tongue. Here the tabs 46p are regularly distributed around the axis A1 of the vibrating device 42. Each tab 46p extends mainly in a radial direction, relative to the axis A1 of the vibrating device 42. Thus, here a longitudinal end of each tab 46p is integral to the cylindrical portion 46c of the frame 46. Each tab 46p has a hole 51 (see FIG. 4).

Each vibrating device 42 is fixed to the support plate 38 at three points, preferably at exactly three points, more preferably at exactly three points evenly distributed around the axis A1 of the vibrating device 42. At each point, a damping element 50 for damping the vibrations of the vibrating device 42 is used. Thus each damping element 50 reduces or even prevents the propagation of the vibrations emitted by the vibrating device 42 towards the support plate 38. Each damping element 50 here takes the form of a pin (or brace or spacer), inserted by force or snap-fitted into a hole 52 in the support plate 38, on the one hand, and into a hole 51 of a tab 46p of the frame 46 of the vibrating device 42, on the other hand.

The damping element 50 is at least partly covered with elastic (or “elastically deformable”) material, at the area where it is in contact with the support plate 38 and the tab 46p of the frame 46 of a vibrating device 42. Alternatively, the damping element 50 has a substantially rigid, cylindrical core, covered over its entire surface by elastically deformable material. According to yet another alternative, the pin 50 is entirely made of elastically deformable material in order to dampen the transmission of vibrations emitted by a vibrating device 42, towards the support plate 38. The elastically deformable material is for example an elastomer such as rubber, ethylene-propylene-diene monomer or “EPDM”, or silicone.

Each damping element 50, in particular the portion made of elastically deformable material, may be more flexible, in particular more elastic, than at least one, preferably each, among the support plate 38 and the tab 46p of the frame 46 of the vibrating device 42, with which it is associated.

The damping element 50 may in particular comprise two circular grooves 50₁, 50₂ on its surface, axially separated by a distance D, one 50₁ of the two circular grooves having a diameter suitable for being received in a hole 52 in the support plate 38, the other 50₂ of the two grooves having a diameter suitable for being received in a hole 51 in a tab 46p of the frame 46 of a vibrating device 42. These two grooves can allow maintaining the tabs 46p of the frame 46 of the vibrating device 42, at a distance from the support plate 38.

The distance D between the two grooves 50₁, 50₂ may be between 10 mm and 20 mm, in particular in the presence of a lumbar support on the backrest 16.

Alternatively, the distance D between the two grooves 50₁, 50₂ may be between 1 mm and 3 mm, in particular in the absence of lumbar support on the backrest 16.

For example, each damping element 50 is inserted into a hole 52, from the first face 38A of the support plate, until a first groove 50₁ of the damping element 50 receives the support plate 38. For this purpose, the first groove 50₁ advantageously has a diameter equal to or even slightly greater than the diameter of the hole 52, in the support plate 38, into which the damping element 50 is inserted.

Once the support plate 38 has been received in the first groove 50₁, the vibrating device 42 is fixed on the damping element 50 by inserting it by force into a hole 51 of a tab 46c of the frame 46 of the vibrating device, until the second groove 50₂ receives the tab 46p. For this purpose, the second groove 50₂ advantageously has a diameter equal to or even slightly greater than the diameter of the hole 51 in the tab 46p.

It is noteworthy that each vibrating device 42 is fixed on the second face 38B of the support plate 38. Thus, each vibrating device 42 extends mainly within the half-space, bounded by the support plate 38, which does not contain an occupant of the motor vehicle seat. In particular, the tabs 46p of the frame 46 of each vibrating device 42 are arranged facing the second face 38B of the support plate 38.

Part of the cylindrical portion 46c of the frame 46 of each vibrating element 42 extends, however, into a respective through-hole 54 in the support plate 38, such that the vibrating element 48 may, at least when it is vibrating, be flush with the support plate 38 at the first face 38A of the support plate 38, or even projecting from the support plate 38 at the first face 38A of the support plate 38.

As can be seen in particular in FIG. 4, a clearance j is preferably maintained between the edge of a hole 54 in the support plate 38 and the vibrating device 42 at least partially received in this hole 54. The clearance j is for example between 2 and 3 mm. Such clearance makes it possible to avoid any direct contact between the vibrating device 42 and the support plate 38, even when an occupant is seated on the vehicle seat and leaning against the backrest 16. This prevents the transmission of vibrations from the vibrating devices 42 directly to the support plate 38. Here, the clearance j is maintained between the frame 46, in particular the cylindrical portion 46p of the frame 46 of the vibrating device 42, on the one hand, and the edge of a hole 54 in the support plate 38, on the other hand.

To control the vibrations of the vibrating devices 42, a control unit is provided, in particular an electronic control unit 56. Here, the unit is fixed to the wire 36, by snap-fitting, above the support plate 38. Other integrations of the electronic control unit 56 are possible, however, depending on the size of this electronic control unit 56 and the configuration of the seat backrest 16. The electronic control unit 56 may control other comfort functions for the occupant of the seat and/or other elements included in the backrest 16, in particular other elements fixed to the support plate 38.

According to the example illustrated, other elements suitable for implementing at least one comfort function for the occupant of the vehicle seat 10, are fixed directly or indirectly to the support plate 38.

Thus, as can be seen in FIGS. 2 and 3 in particular, a fan 58 is fixed on the second face 38B of the support plate 38. Vibration damping elements 60 are also used to fix the fan 58 on the support plate 38, so as to reduce or even prevent the propagation of vibrations produced by the fan 58 during operation, towards the support plate 38. The damping elements 60 may take the form of pins or spacers made of elastic material, in particular made of elastomeric material.

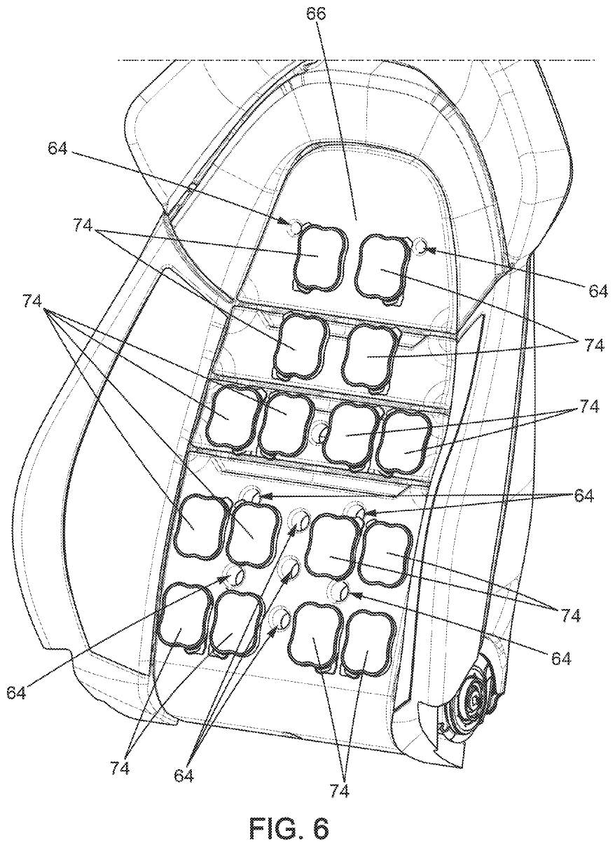

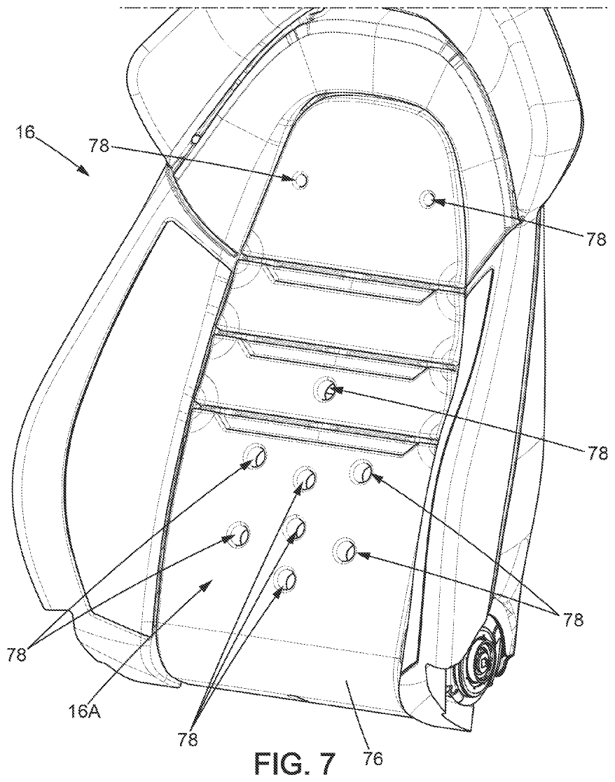

The fan 58 blows into a hole 64 in the support plate 38, in order to be able to blow air towards an occupant of the vehicle seat 10. Holes then need to be provided in the various layers covering the first face of the support plate 38, in particular holes 64, 78 in the padding 66 of the backrest upholstery 16, as shown in FIG. 6, and in the cover 76 over the padding 66, where appropriate, as shown in FIG. 7.

As illustrated also in FIG. 3, a valve 68, here a servo valve 68, is also attached to the second face 38B of the support plate 38, its function to be described further below. An air pump 70 here is fixed to the backrest frame 17, here to an upright 17₁ of the backrest frame 17. Other positions for incorporating the air pump 70 into the backrest 16 may be envisaged, however. The air pump 70 is in fluid communication with the servo valve 68. The servo valve 68 is for example controlled by the electronic control unit 56.

As illustrated in FIG. 4, lumbar support pads 72 are fixed to the first face 38A of the support plate 38. The lumbar support pads 72 are in fluid communication with the servo valve 68. Thus the lumbar support pads 72 can be inflated by air from the air pump 70, via the servo valve 68. Here, the lumbar support pads 72 extend over substantially the entire width of the support plate 38, between the two uprights 17₁, 17₂ of the backrest frame 17. The lumbar support pads 72 are arranged in the lower portion of the backrest 16, in particular in the lower half of the backrest 16, intended to be closest to the seat base 13. The lumbar support pads 72 may be partially superimposed one atop the other. Thus, in the example shown, three lumbar support pads 72 are fixed to the first face 38A of the support plate 38.

Here, each lumbar support pad 72 is in contact with the vibrating element 48 of two respective vibrating devices 42. Indeed, in order to ensure a satisfactory lumbar support function, it has proven preferable to keep lumbar support pads 72 of large size, in particular extending over substantially the entire width of the support plate 38. Under these conditions, it is preferred to maintain the positioning of the vibrating devices 42 at the level of these lumbar support pads 72 and to transmit the vibrations emitted by the vibrating devices 42, via the lumbar support pads 72, inflated where appropriate.

As illustrated in FIG. 6, the backrest 16 may additionally or alternatively be equipped with inflatable pouches 74. These inflatable pouches 74 are of reduced dimensions compared to the lumbar support pads 72. These inflatable pouches 74 are also in fluid communication with the servo valve 68. Thus, these inflatable pouches 74 can be inflated by air from the air pump 70, via the servo valve 68. Here, the servo valve 68 can selectively control the air supply to the various inflatable pouches 74, in particular according to a predetermined sequence, to carry out a back massaging function for the occupant of the vehicle seat 10.

Advantageously, the inflatable pouches 74 are distributed over substantially the entire height of the backrest 16. To do this, these inflatable pouches 74 are fixed to the padding 66 of the backrest 16. The padding 66 may be fixed to the support plate 38, and possibly to the backrest frame 17. The inflatable pouches 74 are thus indirectly fixed to the support plate 38, in that they are fixed to the padding 66 which in turn is fixed to the support plate 38. As already mentioned, holes 64 are provided here in the padding 66 in order to place the holes 78 in the cover 76 covering the backrest 16, in fluid communication with the fan 58.

The inflatable pouches 74 may be evenly distributed across the padding 66, in particular in an array. Thus, the inflatable pouches 74 may be aligned horizontally and/or vertically. Other distributions of the inflatable pouches 74 are conceivable, however.

The padding 66 may have a thickness greater than or equal to 20 mm, preferably greater than or equal to 25 mm. The thickness of the padding 66 may be less than or equal to 35 mm, preferably less than or equal to 30 mm.

The backrest 16 thus obtained is thin. The backrest 16 thus has a reduced size. This is obtained in particular by the attachment of the vibrating devices 42 and, where applicable, other bulky elements contributing to implementing a comfort function for the occupant of the vehicle seat 10, on the second face 38B of the support plate 38.

Thus, the seat backrest may only have some of the comfort functions mentioned above and/or other comfort functions.

When the seat backrest does not have lumbar support pads 72, the vibrating elements 48 of the vibrating devices 42 are advantageously in contact, when they are vibrating, with the padding 66 of the backrest 16.

Other means of fixing the vibrating devices 42 on the support plate 38 are accessible to those skilled in the art, which contribute to attenuating the transmission of vibrations emitted by the vibrating device 42 to the support plate 38. Preferably, however, each vibrating device 42 is fixed to the support plate 38 at at least two points, preferably at at least three points, more preferably at exactly three points. The fixing points of each vibrating device 42 may in particular be regularly distributed angularly in order to facilitate equilibrium in the vibrating device 42. Alternatively, the fixing points may not be regularly distributed, for example in order to create a foolproof positioning connection for mounting the vibrating device 42 on the support plate 38.

Similarly, other means for fixing the support plate 38 to the backrest frame 17 are accessible to those skilled in the art, these fixing means preferably being elastically deformable. This elastic deformation of the means for fixing the support plate to the backrest frame contributes to the comfort of the seat occupant, and also makes it possible to reduce or even prevent the transmission of vibrations from the support plate 38 to the backrest frame 17.

A vibrating device (also called “vibrator” or “exciter”) may be incorporated into a vehicle seat. Such a vibrating device may, in particular, be implemented in order to alert the vehicle seat occupant of a hazard. Such a seat is therefore more particularly intended for the driver of the motor vehicle.

Such a vibrating device may in particular be placed in the backrest of a vehicle seat.

A difficulty specific to incorporating such a comparative vibrating device into a comparative backrest of a motor vehicle seat is to reconcile the occupant's comfort and the occupant's perception of the alert when the vibrating device is put into use.

Thus, placing the comparative vibrating device in contact with the occupant of the seat makes it possible to obtain good perception. In this case, however, the comfort of the occupant is reduced, as he or she may feel discomfort due to contact with the comparative vibrating device.

Also, attaching such a comparative vibrating device to the frame of the comparative seat backrest tends to cause the frame to vibrate in reaction to the use of the comparative vibrating device. Here again, the comfort of the seat occupant is then reduced too much for this solution to be put into practice.

There therefore remains a need for a backrest of a motor vehicle seat incorporating a vibrating device and not having at least some of the above disadvantages.

To this end, a vehicle seat backrest is described comprising a backrest frame, a support plate fixed to the backrest frame, and at least one vibrating device, each vibrating device being fixed to the support plate by means of at least one damping element.

Thus, advantageously, each vibrating device is at least partially isolated from the seat base frame by the damping element or elements. In addition, it should be noted that this solution is particularly compact and makes it possible to produce a thin seat backrest.

According to preferred embodiments, the vehicle seat backrest comprises one or more of the following features, alone or in combination:
the support plate comprises a first face intended to be oriented towards an occupant of the vehicle seat and a second face opposite to the first face, each vibrating device being fixed on the second face of the support plate, at least a portion of each vibrating device being received in a respective through-hole in the support plate;
each vibrating device is fixed to the support plate at at least two points, preferably at at least three points, more preferably at exactly three points, the at least two points preferably being evenly distributed angularly around the vibrating device;
at least one damping element in the form of a pin made at least partly of elastic material, preferably entirely of elastic material, is fixed on the support plate on the one hand, and on the vibrating device on the other hand, at each point where the vibrating device is fixed on the support plate;
each pin forming a damping element comprises a first groove for fixing the pin to the support plate, and a second groove at a distance from the first groove, for fixing to the vibrating element, the second groove preferably receiving a tab of the vibrating device;
the support plate is fixed to the backrest frame by elastically deformable fixing means;
the backrest frame comprises a first upright, a second upright, a first crosspiece, and a second crosspiece, the elastically deformable fixing means comprise at least one spring wire fixed to the first crosspiece and to the second crosspiece, and the support plate is preferably fixed to the at least one spring wire, in particular by snap-fitting;
the vehicle seat backrest comprises an electronic control unit for controlling the at least one vibrating device, the electronic control unit being fixed to the at least one spring wire, in particular by snap-fitting;
at least one element contributing to the implementation of a comfort function, is directly or indirectly fixed to the support plate;
a fan is fixed to the support plate, preferably on the second face of the support plate, the fan and the seat backrest being shaped so that the air blown by the fan is blown out of the backrest via the face of the backrest intended to be oriented towards an occupant of the vehicle seat;
at least one, preferably at least two, more preferably at least three lumbar support pads are directly or indirectly fixed to the support plate, preferably on the first face of the support plate intended to be oriented towards an occupant of the vehicle seat, each vibrating device preferably also being in contact with a lumbar support pad;
a plurality of inflatable pouches are fixed to the support plate, preferably on the first face of the support plate intended to be oriented towards an occupant of the vehicle seat, via padding of the backrest where appropriate, the inflatable pouches being supplied with air by an air pump via a valve, the valve also being fixed to the support plate, preferably on the second face of the support plate;
each vibrating device is partially received in a respective hole in the support plate, with a clearance, the clearance preferably being between 2 mm and 3 mm;
the seat backrest further comprises padding fixed to the backrest frame and/or the support plate, the padding preferably having a thickness of between 20 mm and 35 mm, more preferably between 25 mm and 30 mm.

According to another aspect, also described is a vehicle seat comprising a seat base, with a seat base frame, and a backrest as described above in all its combinations, the backrest frame being fixed to the seat base frame, preferably in a manner enabling it to pivot about a transverse axis.

According to yet another aspect, a method is described for mounting a seat backrest as described above in all its combinations, comprising the steps of:

i) providing a backrest frame, a support plate, at least one vibrating device, and at least one damping element in the form of a pin made at least partly of elastic material, having a first groove and a second groove;

ii) inserting the at least one damping element into a hole in the support plate via the first face of the support plate, the face being intended to be oriented towards an occupant of the vehicle seat, until the first groove receives the support plate;

iii) fixing the vibrating device (42) on the at least one damping element, preferably until the second groove receives a tab of the vibrating device;

iv) fixing the support plate to the backrest frame.

The support plate may be fixed on the backrest frame before or after the vibrating device is fixed on the support plate.

1. A backrest of a vehicle seat, comprising
a backrest frame,
a support plate fixed to the backrest frame, and
at least one vibrating device, each vibrating device being fixed to the support plate by means of at least one damping element.

2. The backrest of claim 1, wherein the support plate comprises a first face intended to be oriented towards an occupant of the vehicle seat and a second face opposite to the first face, each vibrating device being fixed on the second face of the support plate, at least a portion of each vibrating device being received in a respective through-hole in the support plate.

3. The backrest of claim 1, wherein each vibrating device is fixed to the support plate at at least two points.

4. The backrest of claim 3, wherein the at least two points are evenly distributed angularly around the vibrating device.

5. The backrest of claim 1, wherein at least one damping element in the form of a pin made at least partly of elastic material is fixed on the support plate on the one hand, and on the vibrating device on the other hand, at each point where the vibrating device is fixed on the support plate.

6. The backrest of claim 5, wherein each pin forming a damping element comprises a first groove for fixing the pin to the support plate, and a second groove at a distance from the first groove, for fixing to the vibrating element.

7. The backrest of claim 1, wherein the support plate is fixed to the backrest frame by elastically deformable fixing means.

8. The backrest of claim 7, the backrest frame comprising a first upright, a second upright, a first crosspiece, and a second crosspiece, the elastically deformable fixing means comprising at least one spring wire fixed to the first crosspiece and to the second crosspiece.

9. The backrest of claim 8, wherein the support plate is fixed to the at least one spring wire.

10. The backrest of claim 8, comprising an electronic control unit for controlling the at least one vibrating device, the electronic control unit being fixed to the at least one spring wire.

11. The backrest of claim 1, wherein at least one element contributing to the implementation of a comfort function, is directly or indirectly fixed to the support plate.

12. The backrest of claim 11, wherein a fan is fixed to the support plate, the fan and the seat backrest being shaped so that the air blown by the fan is blown out of the backrest via the face of the backrest intended to be oriented towards an occupant of the vehicle seat.

13. The backrest of claim 12, wherein the support plate comprises a first face intended to be oriented towards an occupant of the vehicle seat and a second face opposite to the first face and wherein the fan is fixed on the second face of the support plate.

14. The backrest of claim 11, wherein at least one lumbar support pad is directly or indirectly fixed to the support plate.

15. The backrest of claim 11, wherein a plurality of inflatable pouches are fixed to the support plate, preferably on the first face of the support plate intended to be oriented towards an occupant of the vehicle seat, via padding of the backrest where appropriate, the inflatable pouches being supplied with air by an air pump via a valve, the valve also being fixed to the support plate, preferably on the second face of the support plate.

16. The backrest of claim 1, wherein each vibrating device is partially received in a respective hole in the support plate, with a clearance.

17. The backrest of claim 16, wherein the clearance is between about 2 mm and about 3 mm.

18. The backrest of claim 1, further comprising padding fixed to at least one among the backrest frame and the support plate.

19. A vehicle seat comprising a seat base, with a seat base frame, and the backrest according to claim 1.

20. A method for mounting the backrest according to claim 1, comprising the steps of:
i) providing a backrest frame, a support plate, at least one vibrating device, and at least one damping element in the form of a pin made at least partly of elastic material, having a first groove and a second groove;
ii) inserting the at least one damping element into a hole in the support plate via the first face of the support plate, the face intended to be oriented towards an occupant of the vehicle seat, until the first groove receives the support plate;
iii) fixing the vibrating device on the at least one damping element; and
iv) fixing the support plate to the backrest frame.
